(19) United States
(12) Patent Application Publication
(10) Pub. No.: US 2011/0119730 A1
(43) Pub. Date: May 19, 2011

(54) Enforcing Centralized Communication Policies

(76) Inventors: Rotem Eldar, Cambridge, MA (US); Hagal Vered, Petach Tikva (IL); Yuval Pemper, Shoham (IL)

(21) Appl. No.: 12/774,619

(22) Filed: May 5, 2010

Related U.S. Application Data
(60) Provisional application No. 61/176,444, filed on May 7, 2009.

(51) Int. Cl. G06F 21/00

(52) U.S. Cl. 726/1

(57) ABSTRACT

A system provides centralized policies to be applied in a distributed manner to all communication channels used by a set of mobile communication devices, including communication channels which do not pass through a centralized communication server, such PIN-to-PIN communication channels. Such policies may include address-based and content-based policies. The system also allows all such communications to be archived.

### CROSS-REFERENCE TO RELATED APPLICATIONS

This application claims priority from commonly-owned U.S. Prov. App. Ser. No. 61/176,444, filed on May 7, 2009, entitled, “Enforcing Centralized Communication Policies.”

### BACKGROUND

Enterprises typically provide their users with desktop and laptop computers for accessing important enterprise information. In recent years, enterprises have increasingly allowed their users to access such enterprise information using wireless computing devices such as, for example, the BlackBerry® hand-held device from Research in Motion Limited and the iPhone from Apple Computer, Inc. System infrastructures (or architectures) supporting such devices may generally comprise a wireless network, a carrier gateway, an enterprise gateway, and other back-end servers (e.g., Microsoft Exchange, database systems, document management systems, etc.), or other components.

Certain wireless devices have a dedicated device number, sometimes referred to as a personal identification number or “PIN,” which may serve as the device's identifier on a network. PINs also enable wireless devices on a network to communicate with one another via PIN-to-PIN messaging. This form of communication may occur from device to device through the wireless network, and without the need for an enterprise gateway or server.

Other communication options for transmitting messages from one mobile device to another, without going through an enterprise server or an enterprise gateway, include Short Message Service (SMS), Multimedia Messaging Service (MMS), Instant Messaging (IM), and web mail. Even when mobile device users use such messaging technologies for business communications on devices provided to them by the enterprise, the messages themselves are typically serviced by a wireless carrier and do not pass through any enterprise controlled server or gateway. This may result in a variety of problems, as illustrated by the following example.

Companies often have strict policies related to their electronic communication, either due to regulations or due to their desire to prevent leakage and loss of confidential and private information. Such policies can be, but are not limited to, content-based and address-based policies. Content-based policies define whether it is permissible for a message to be transmitted or received based on the content of the message. For example, words and phrases can be defined in a lexicon, and regular expressions can be defined for certain types of fields, such as credit card numbers or social security numbers. Enforcement of such policies typically requires that the content of incoming and outgoing messages be scanned to determine whether such content complies with the policies. If such scanning identifies content that has been defined as prohibited or otherwise actionable by a policy, then an action specified by the policy (such as blocking transmission or receipt of the message) is performed.

Address-based policies are based on the source and the target of the communication. Ethical walls, for example, prohibit communication between certain departments of a company, or between certain departments in the company and the outside world.

Companies typically use their servers to enforce both content-based and address-based policies against company communications. Server-based enforcement can be an effective way to enforce policies against communications, such as enterprise email messages, which pass through the enterprise's servers. The enterprise's servers, however, cannot be used to enforce policies against messages, such as PIN-to-PIN messages, which do not pass through the enterprise's servers or gateways. As a result, in many enterprises, policies are not enforced against such messages. As a result, enterprises often fail to obtain the benefits of their communication policies in relation to such messages, thereby exposing themselves to the same risks associated with the lack of such policies.

Furthermore, archiving of such communication is also desired for various purposes, such as complying with regulations or providing proof in case of litigation. To date, archiving is usually performed by monitoring centralized servers (such as the company's email servers) or network gateways (e.g., by using firewalls). Such an approach cannot be used to archive messages which are communicated by one mobile device to another without passing through an enterprise server or gateway. As a result, the enterprise may fail to archive messages which the enterprise is legally required to archive, but which fail to pass through any of the enterprise's servers or gateways. This may result not only in loss of valuable enterprise information but also possibly in legal liability or failure to win a lawsuit due to lack of necessary evidence.

At least one solution exists for archiving messages transmitted and received by a Blackberry device using the device's existing message logging capabilities. Communications such as SMS messages are written to a log file within the device after they are sent or received. An enterprise server periodically reads updates from the log file and adds the received information to the enterprise's communication archive. There are several disadvantages to such an approach. First, the log only contains the phone numbers used for the SMS; no additional contact information is available about the communication. This is disadvantageous because, for example, e-discovery systems usually provide search capabilities that are based on email addresses. Second, there is a time delay between the actual transmission or receipt of the message and the time at which the log file is read by the enterprise server. During that time, a user may prevent communication of the log information to the server, such as by turning off the mobile device. Alternatively, for example, the user may edit the log file and delete the record of the message, thus hiding the existence of the message from the enterprise. As yet another example, the user may edit the log file to provide false information, such as the identity of the message recipient, thereby causing such false information to be archived by the enterprise.

### SUMMARY

A system provides centralized policies to be applied to all communication channels used by a set of mobile communication devices, enforcing these policies in a distributed manner at the end-point, to include communication channels which do not pass through a centralized communication server, such as SMS, MMS, PIN-to-PIN and IM communication channels. Such policies may include, but are not limited to, address-based and content-based policies. The system also allows all such communications to be archived.

Other features and advantages of various aspects and embodiments of the present invention will become apparent from the following description and from the claims.

### BRIEF DESCRIPTION OF THE DRAWINGS

FIG. 1 is a dataflow diagram of a system for initializing end-point enforcement of centralized communication policies according to one embodiment of the present invention;

FIG. 2 is a flowchart of a method performed by the system of FIG. 1 according to one embodiment of the present invention;

FIG. 3 is a dataflow diagram of a system for archiving messages according to one embodiment of the present invention;

FIG. 4 is a flowchart of a method performed by the system of FIG. 3 according to one embodiment of the present invention;

FIG. 5 is a dataflow diagram of the end-point portion of a system for scanning and blocking messages according to centralized communication policies according to one embodiment of the present invention;

FIG. 6 is a flowchart of a method performed by the system of FIG. 5 according to one embodiment of the present invention;

FIG. 7 is a flowchart of a method for delaying transmission/reception of a message while the message is reviewed for compliance with communication policies according to one embodiment of the present invention; and

FIG. 8 is a dataflow diagram of a system for performing the method of FIG. 7.

### DETAILED DESCRIPTION

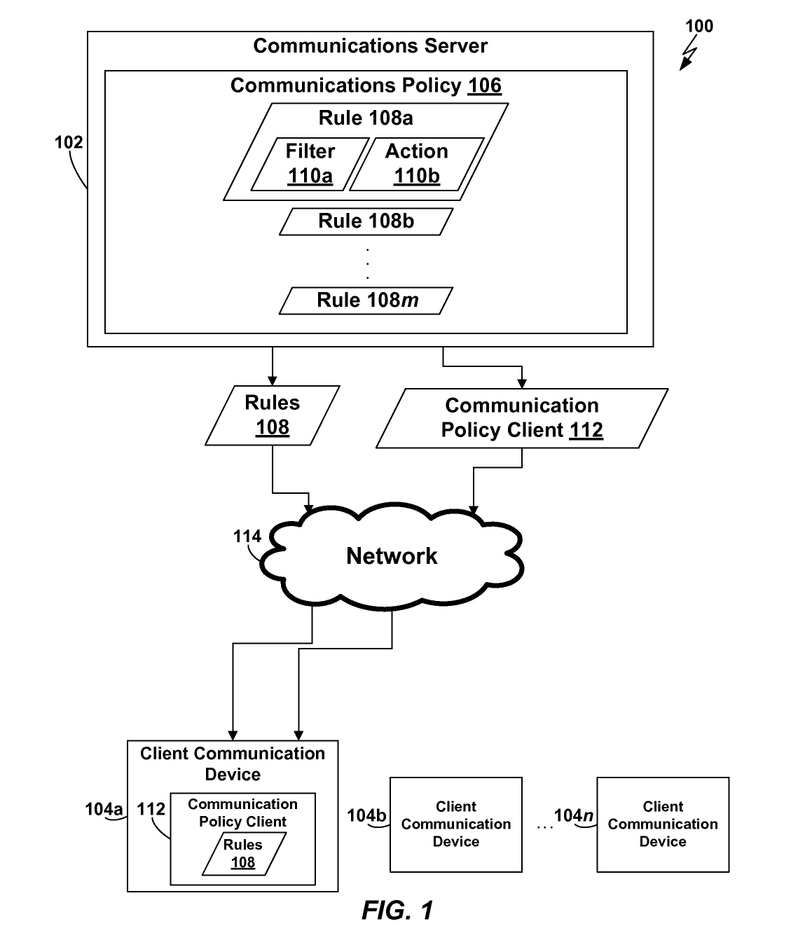

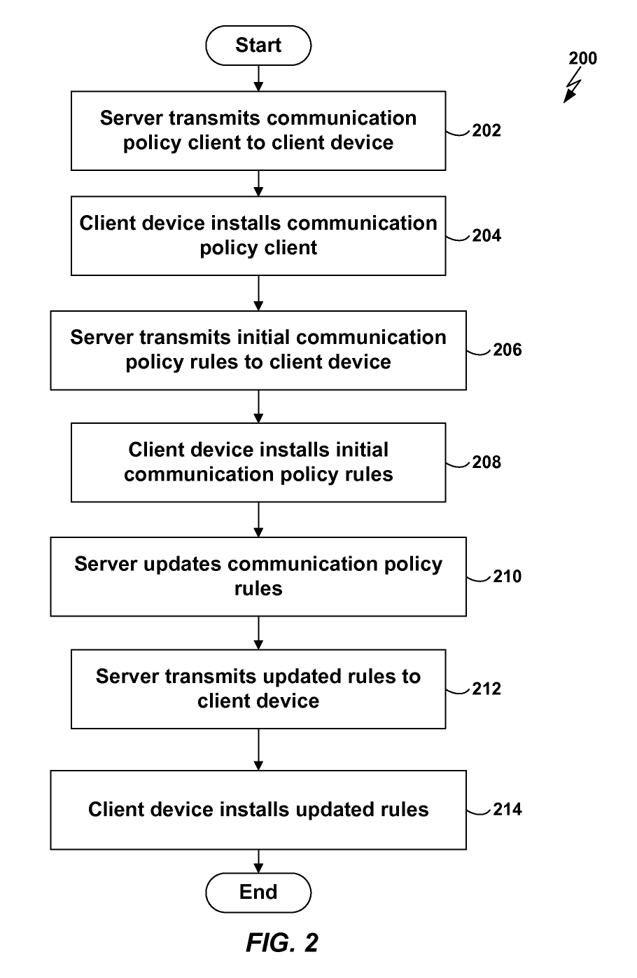

Referring to FIG. 1, a dataflow diagram is shown of a system 100 for initializing distributed enforcement of centralized communication policies according to one embodiment of the present invention. Referring to FIG. 2, a flowchart is shown of a method 200 performed by the system 100 of FIG. 1 according to one embodiment of the present invention.

The system 100 includes a server 102 and one or more clients 104a-n. The server 102 may, for example, be implemented on a single computing device or on a combination of multiple computing devices. The clients 104a-n may, for example, be mobile communication devices, such as cellular telephones, smart phones, personal digital assistants (PDAs), or any combination thereof. The client communication devices 104a-n may differ from the computing device on which the communications server 102 is implemented. For example, the communications server 102 may be implemented on a single server computer, while the client communication device 104a may be a separate mobile computing device, such as a cellular telephone.

Although three clients 104a-n are shown in FIG. 1 for ease of illustration, this is merely an example and does not constitute a limitation of the present invention. Rather, the system 100 may include any number of clients. Similarly, although one server 102 is shown in FIG. 1 for ease of illustration, this is merely an example and does not constitute a limitation of the present invention. Rather, the system 100 may include any number of servers.

In the following example, the server 102 will be described as being associated with (e.g., owned and/or operated by) a particular company. The server 102 contains, or otherwise has access to, the communication policy 106 of the company, defined by one or more rules 108. Although three rules 108a-m are shown in FIG. 1 for purposes of example, there may be any number of rules. In the example shown in FIG. 1, rule 108a includes a filter 110a and a corresponding action 110b. The filter 110a defines the communications which trigger performance of the action 110b by the server. Such communications are described herein as “satisfying” the rule 108a. Although not shown in FIG. 1 for ease of illustration, each of the remaining rules 108b-m has its own filter and action. The filters may, for example, be content-based filters, addressed-based filters, or other kinds of filters in any combination.

The server 102 may provide a user interface for defining each of the rules 108. Users, such as system administrators, may access the server 102 by, for example, logging in directly to the server 102 or via a web-based interface. The server 102 may interface with the user applications using, for example, any of a variety of remote procedure call (RPC) technologies, such as DCOM, RMI, and SOAP.

Each of the client communication devices 104a-n may or may not include a communication policy client. For ease of illustration, only the communication policy client 112 of client device 104a is shown in FIG. 1. However, any of the techniques disclosed herein in connection with the communication policy client 112 on client device 104a may be applied equally to instances of the communication policy client on any of the other client devices 104a-n. The techniques described herein may be used in connection with a client device, such as client device 104a, containing the communication policy client 112, whether or not the device with which the client device communicates contains its own communication policy client. Furthermore, the techniques described herein may be used in connection with a client device, such as client device 104a, containing the communication policy client 112, whether or not the device with which the client device communicates is within the same network or enterprise as the client device. As a result, the company's communication policy 106 may be enforced against incoming and outgoing communications of the client device 104a independently of the properties of the device with which the client device 104a communicates.

Due to the multitude of platforms and operating systems, the communication policy client 112 may be implemented in any of a variety of ways. Different implementations of the communication policy client may be used on different client devices. Examples of such platforms and operating systems include, but are not limited to, Blackberry® platforms, iPhone platforms, Windows Mobile operating systems, and Symbian operating systems.

The communication policy client 112 may be installed onto the client communication device 104a by, for example, transmitting the client 112 from the server 102 to the client communication device 104a over a network 114 (FIG. 2, step 202), in response to which the client communication device 104a may install the communication policy client 112 onto itself (step 204). The network 114 may be any kind of network, such as the public Internet or a private intranet. Furthermore, the network 114 may be a wired network, a wireless network, or any combination thereof. In the case in which the network 114 is at least in part a wireless network 114, the server 112 may transmit the client 112 to the client communication device 104a over the air. The term “network” as used herein includes direct device-to-device connections, such as a direct cable (e.g., USB) connection from the client device 104a to a computer (such as the server 102).

The server 102 may also transmit some or all of an initial set of the rules 108 over the network 114 (e.g., over the air) to the client communication device 104a (step 206). The client communication device 104a receives the initial rules 108, in response to which the client communication device 104a may install the initial rules 108 onto itself (step 208). Installing the rules 108 may include, for example, storing the rules on a computer-readable medium (such as a disk drive or flash memory) within or connected to the client communication device 104a. If any of the rules 108 are updated (modified), or if rules are deleted or added (step 210), the server 102 may notify the client communication device 104a of such updates (step 212). The client communication device 104a receives the update notification(s), in response to which the client communication device 104a may update its internal copy of the rules 108 (step 214). As a result, the rules 108 may stay in sync on both the server 102 and the client 104a. The server 102a may notify the client 104a of rule updates in any way, such as by transmitting some or all of the updated rules to the client device 104a, or by providing the client device 104a with instructions for updating its copy of the rules 108.

The server 102 may interface with the rest of the company's backbone, allowing the server 102 access to information such as the company's directory. The interface may be implemented using any of a variety of remote procedure call (RPC) technologies, such as DCOM, RMI, and SOAP. Furthermore, the server 102 may provide an interface for controlling the mobile communication devices 104a-n, and a user interface required for such control. Furthermore, the server 102 may provide a user interface for an auditor or reviewer of messages, either for approval or rejection of messages that are flagged for review, or for reviewing archived messages in case the company prefers not to use a third party e-discovery tool.

Although the communication policy 106 is shown as a single policy in FIG. 1 for ease of illustration, in practice the policy 106 may be implemented as multiple policies (e.g., a content-based policy and an address-based policy, or distinct policies for different departments or individuals in the company). The server 102 may control the application of different sets of rules 108 to different groups and/or individuals. Different client devices may contain and apply different sets of rules. For example, the server 102 may transmit to the client device 104a only those rules which apply to the user of the device 104a, as may be defined by the individual identity of the user and/or the membership of the user within one or more groups. Similarly, the server 102 may transmit to the client device 104b only those rules which apply to the user of the device 104b. The rules transmitted to, and subsequently applied by, client devices 104a and 104b may differ from each other. Such multiple rule sets may, for example, be implemented using an existing directory (e.g., a Microsoft Active Directory) of the users and groups defined in the company's network.

The communication policy client 112 monitors communication transmitted and received by the client device 104a, even if such communication does not pass through the server 102 or through any of the company's other servers or gateways. The monitoring may be performed in real time, as the communication occurs, which guarantees that all messages are checked against the latest rules 108 and that all messages are archived.

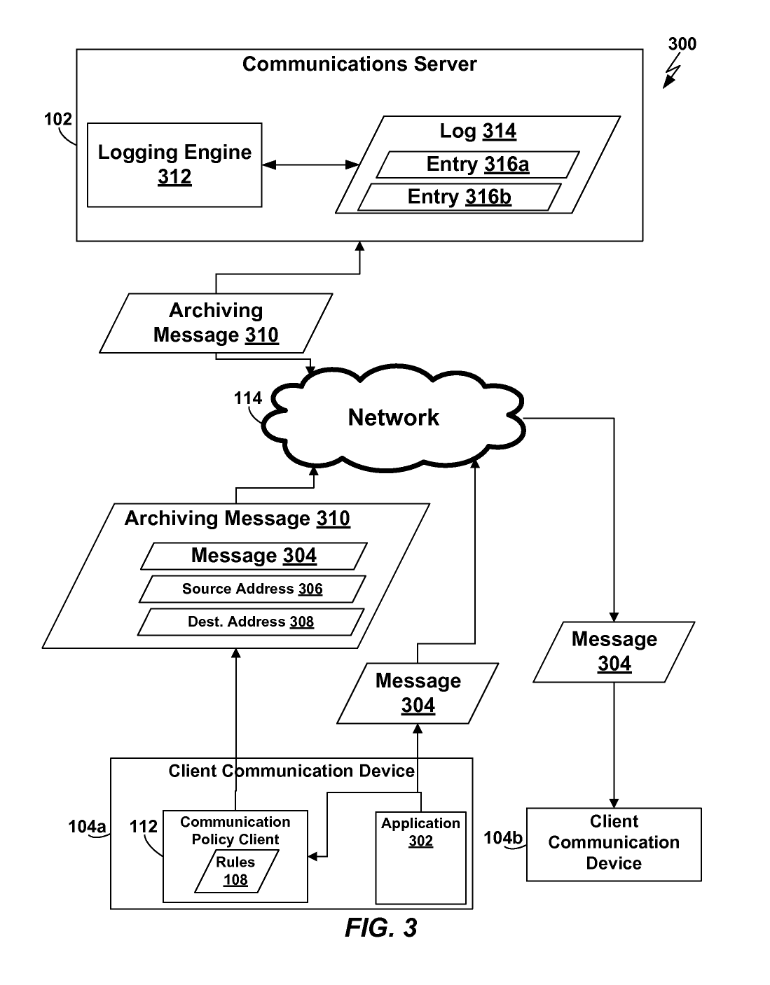

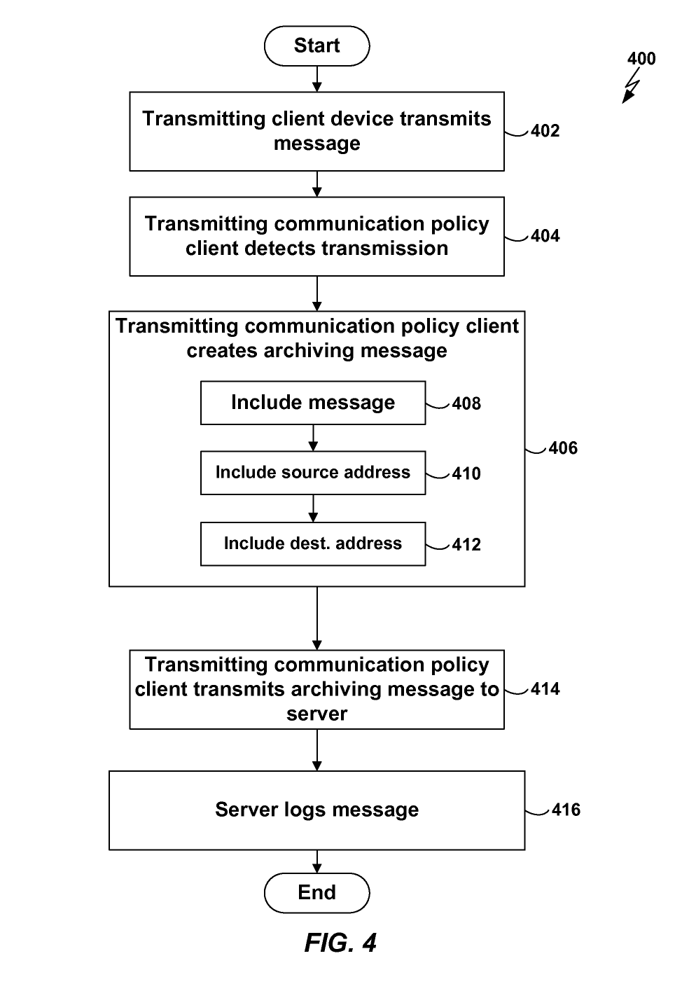

Referring to FIG. 3, a dataflow diagram is shown of a system 300 for archiving messages according to one embodiment of the present invention. Referring to FIG. 4, a flowchart is shown of a method 400 performed by the system 300 of FIG. 3.

When the client communication device 104a transmits a message 304 of any kind (FIG. 4, step 402), including messages such as PIN-to-PIN or SMS messages which do not pass through the company's servers or gateways, the device's communication policy client 112 detects the message transmission (step 404). FIG. 3 illustrates an example in which an application 302 (such as an email or SMS client application) residing on the client communication device 104a attempts to transmit the message 304, in response to which the message 304 is detected by the communication policy client 112.

In response to the detection, the communication policy client 112 creates an archiving message 310, such as an email message, containing relevant information about the original message 304 for archiving purposes (step 406). Note that although in the present example an email message is used, the archiving message 310 may take other forms. As this example indicates, the communication channel and communication protocol that is used to transmit/receive the original message 304 may differ from the communication channel and communication protocol that is used to transmit/receive the archiving message 310. For example, the original message 304 may be an SMS message, while the archiving message 310 may be an email message.

The communication policy client 112 includes in the archiving message 310 information such as: (1) a copy or summary of the original message 304 (step 408); (2) one or more addresses 306 or other identifiers (e.g., phone number, email address, IM address) of the source device 104a and/or human sender of the message 304 (step 410); and (3) one or more addresses 308 or other identifiers of the recipient device 104b and/or human recipient of the message 304 (step 412). Note that these are merely examples of information that may be included in the archiving message 310. The communication policy client 112 transmits the archiving message 310 to the server 102 (step 414), which uses a logging engine 312 to create a log entry 316a containing the message 310 or information derived from the message 310 (step 416).

A similar procedure may be followed by the communication policy client 112 on the client communication device 104a to create a log entry 316b in response to receiving a message from a transmitting device, whether or not the message was transmitted using an instance of the communication policy client 112. Assuming for purposes of example that the client communication device 104a receives a message after transmitting the message 304, the result of logging the message transmitted by and the message received by the client communication device is two log entries 316a and 316b, one for the transmitted message 304 and one for the received message. The log 314 may be represented in any form, such as a list, database table, or a first-in first-out queue.

A variety of mechanisms may be used to store the archiving message 310 securely on a computer-readable medium within or connected to the client communication device 104a. Such secure storage may be used to prohibit users of the device 104a from thwarting archiving of the message 304 by performing actions such as turning off the device 104a, disconnecting the device 104a from the network 114, etc. For example, if the communication policy client 112 attempts to send the archiving message 310 to the server 102 but the attempt fails for some reason (e.g., the server 102 is down), the communication policy client 112 may securely save the archiving message 310 internally and repeatedly re-attempt the transmission to the server 102 until the transmission succeeds.

The client 112 may save the archiving message 310 securely in a variety of ways. For example, the client 112 may store the archiving message 310 in a form which hides contents of the archiving message 310 from users of the client device 104a. This may be done, for example, by encrypting the message 310, keeping it in a hidden location on the device 310, storing it in a file having a hidden file attribute in the client device's file system, or keeping it in a file with limited access privileges. These and other techniques may be used not only to hide the contents of the archiving message 310 from the users of the device 104a, but also to protect the archiving message 310 against deletion and modification by users of the device 104a.

The client 112 may also save the archiving message 310 in a form that is not subject to deletion when the device is turned off. For example, the client 112 may store the archiving message 310 in a nonvolatile storage medium, such as a hard disk or flash memory, that does not lose its contents when the device 104a is turned off or otherwise loses power.

Additional information may be added to the archiving message 310 before it is archived. Such information may be added by the client 104a before sending the message 310 or by the server 102 after it receives the message 310 from the client 104a. As an example of the latter, the logging engine 312 may add a receipt timestamp to the message 310 for inclusion in the log entry 316a.

Another example of information that may be added to the message 310 for inclusion in the log entry 316a is additional information about the addresses 306 and/or 308 in the message 310. For example, if the message 304 is an SMS message between two phone numbers, the client 112 may search for the phone numbers in the contact list of the client device 104a and add any additional matching information such as name or email address to make the phone number easier to recognize, or to enable search functionalities in the archiving system that rely on email addresses or names. If an email account of the user of the client device 104a has been configured on the client device 104a, the communication policy client 112 may extract the email address (and/or other identifying information) of the user of the client device 104a and include the email address within the archiving message 310. This feature may be particularly useful if the user of the client device 104a has recently switched from using a different client device to the client device 104a, since the recipient of the message 304 may not otherwise easily recognize the sender of the message 304 based on the telephone number of the device 104a alone. Similar data can be added on by the server 102 upon receipt of the message 310, either by providing the server 102 with an updated directory of phone numbers, names, and email addresses, or by interfacing the server 102 with such a directory in the company's network.

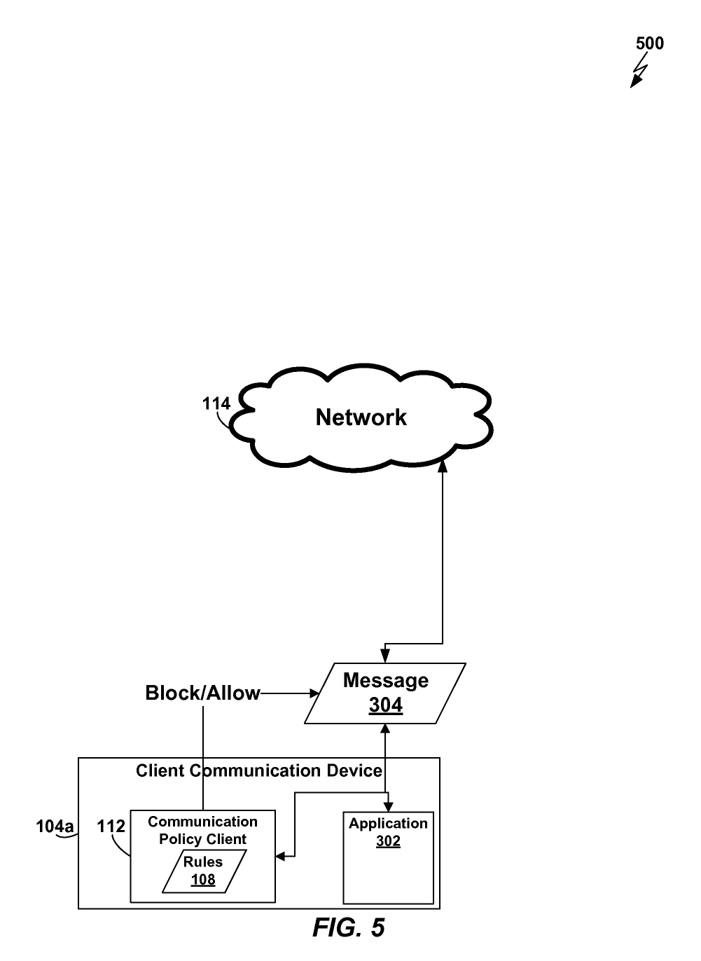

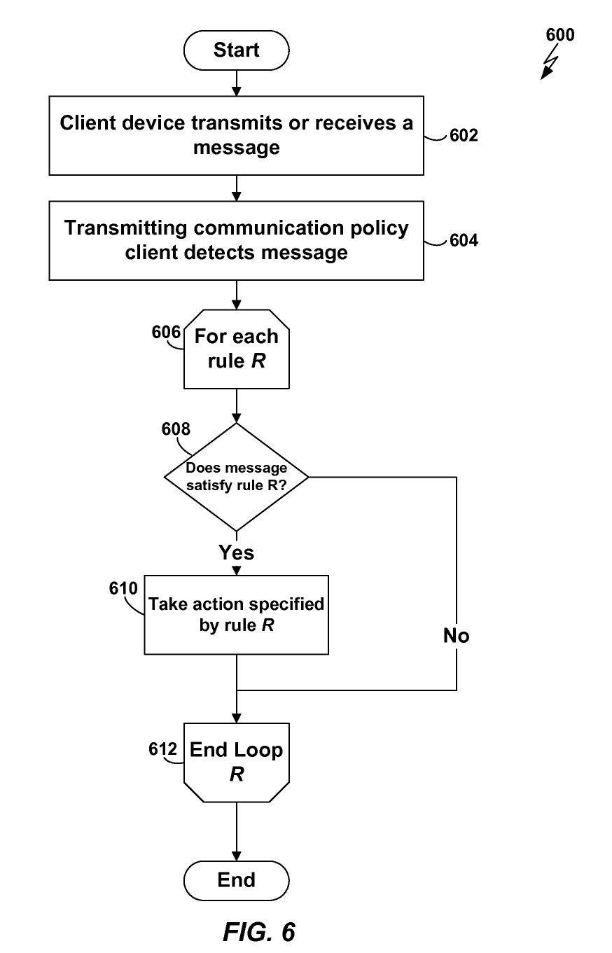

Embodiments of the present invention may also be used to scan and block incoming and outgoing messages according to the policies defined by the rules 108. Referring to FIG. 5, a dataflow diagram is shown of a system 500 for performing such scanning and blocking according to one embodiment of the present invention. Referring to FIG. 6, a flowchart is shown of a method 600 performed by the system 500 of FIG. 5. Although FIG. 5 shows an example in which the client communication device 104a performs the method 600, the same method 600 may be performed by communication policy clients on any of the client communication devices 104a-n as messages are transmitted and received by such devices 104a-n.

Whenever the client device 104a transmits or receives a message 304 (FIG. 6, step 602), including messages such as PIN-to-PIN or SMS messages which do not pass through the company's servers or gateways, the device's communication policy client 112 detects the message 304 (step 604). FIG. 5 illustrates an example in which application 302 attempts to send or receive the message 304, in response to which the message 304 is detected by the communication policy client 112.

In response to the detection, the communication policy client 112 may determine whether the message satisfies any of the rules 108 stored locally on the client communication device 104a. As a result, the client 112 may apply the rules 108 without communicating with the server 102, and may do so even if the server 102 is down or inaccessible (e.g., while there is no network connection between the client communication device 104a and the server 102).

Recall that a message is said to “satisfy” a rule, such as the rule 108a shown in FIG. 1, if the message passes the rule's filter 110a. Such a message triggers performance of the action 110b specified by the rule. Therefore, the communication policy client 112 enters a loop over each local rule R (step 606). For each such rule R, if the message satisfies rule R (step 608), the communication policy client 112 takes the action specified by rule R (step 610). Such an action may, for example, be blocking or allowing the message to be transmitted or displayed. The communication policy client 112 repeats steps 608-610 for the remaining rules (step 612).

The communication policy client 112 may determine whether the message satisfies a particular rule R (step 608 above) in any of a variety of ways. For example, if rule R is an address-based rule, the communication policy client 112 may use the source (sender) and/or target (recipient) addresses of the message to determine whether the message satisfies rule R. Each such address may, for example, be an address of the sending or receiving device, or an address (or other personal identifier) of a human sender or recipient of the message, such as an email address or telephone number.

As another example, assuming for purposes of example that rule R is a content-based rule, the communication policy client 112 may scan the contents of the message, such as its body, subject, and other headers. The client 112 may use such contents to determine whether the message satisfies rule R.

Content-based rules may be defined, for example, based on a lexicon of words and phrases, such as by using wildcards for defining a template (e.g., for identification of a social security number format), by looking for words in proximity to one another, by defining regular expressions, or by any other form of search capability that scans text.

As another example, the rules 108 may act as a “whitelist” which specifies source and/or destination addresses which are allowed to transmit/receive messages, or as a “blacklist” which specifies source and/or destination addresses which are prohibited from transmitting/receiving messages. The rules 108 may, however, specify which communications are permitted in other ways.

If an incoming message is blocked (i.e., if the message satisfies a rule and the action specified by the rule is to block the message), then the message is not displayed to the user of the device 104a. If an outgoing message is blocked, then the message is not transmitted from the outgoing client device 104a. Incoming or outgoing blocked messages may also be deleted, encrypted, or otherwise stored in a way that prevents them from being subsequently accessed by the user of the device 104a.

The client 112 may block communications “silently” (i.e., without notifying the user of the device 104a), or the client 112 may notify the user that a communication has been blocked. The client 112 may also be configured to send an alert to an administrator of the device 104a or the server 102 about the blocked communication. In such a case, the content of the blocked communication may be added to the notification, optionally along with additional information about the source/destination addresses, such as in the ways described above in connection with archiving.

In the case of an outgoing communication that is blocked, the communication policy client 112 may inform the user that the communication was blocked and display the rule(s) that triggered the blockage. The communication policy client 112 may provide the user with an opportunity to modify the outgoing message (such as by editing it) in an effort to make the modified message comply with the rules. The communication policy client 112 may receive the modified message from the user and again apply the local rules to the modified message. If the modified message does not satisfy the local rules, the communication policy client 112 may send the modified message. Providing the user with such notice and opportunity to revise the message trains the user about the company's policies.

Address-based policies may be applied to various types of messages, including voice calls, where the calling number and the called numbers are considered the addresses of the message. In such an implementation the content cannot be sent to an administrator or an auditor, and only the fact that such a call was attempted can be reported.

The client 112 may aggregate multiple messages coming from the same source or going to the same target over a configurable period of time (e.g., 30 minutes) and treat them as a single message for purposes of applying the rules 108. In case a user of the device 104a tries to bypass the content search rules by breaking a message into multiple allowed messages over a short period of time, the client 112 may aggregate all such messages and scan the content as if they were a single message. If the client 112 identifies that the aggregated message is not allowed by the company's policies, it may block the last message, send the entire aggregated message to an auditor, etc.

Other policies may be implemented for determining whether or not a message should be allowed or blocked. All such policies may be implemented in the same manner and controlled by the same client 104a as described above. Additional policies include, for example, policies based on time of day with or without a combination of day of the week or a date (any of which may be associated with either the time of message transmission or time of message receipt), policies based on types or number of attachments, policies based on content scanning of attachments, policies based on the location of the client device 104a (such as may be determined, for example, using GPS technology), and policies based on message metadata (such as the “importance” field of the message). Any of the types of policies described herein may be combined with each other in any combination.

As yet another example, a policy may be based on message type, such as message protocol. For example, a particular policy may only apply to email messages or to SMS messages. One way to define such a policy is by using a rule containing one filter which specifies a particular message type (e.g., message protocol), in addition to other filters (such as content-based and/or address-based filters). As a result, the rule's other filters are applied only to messages of the specified type. Such a filter effectively specifies the message type to which the rule applies.

Another example of a policy which may be enforced in the manner described above is a policy triggered randomly based on a configurable threshold (e.g., probability of 0.1% for flagging a message). Although this type of policy will not usually be used for blocking messages, it may be used for sending random messages to an auditor for random auditing of communication. It may also be used for generating an occasional notification to the user of the device 104a, reminding him of the existence of policies and asking for approval for sending the message. This may be used for training purposes and for reminding employees that communication is being monitored.

The client 112 on the device 104a may provide the system with enhanced auditing capabilities. As mentioned before, the client 112 may send a message to an auditor or an administrator. Even allowed (non-blocked) messages may be sent for auditing. This functionality may be further enhanced using the client 112 on the device 104a.

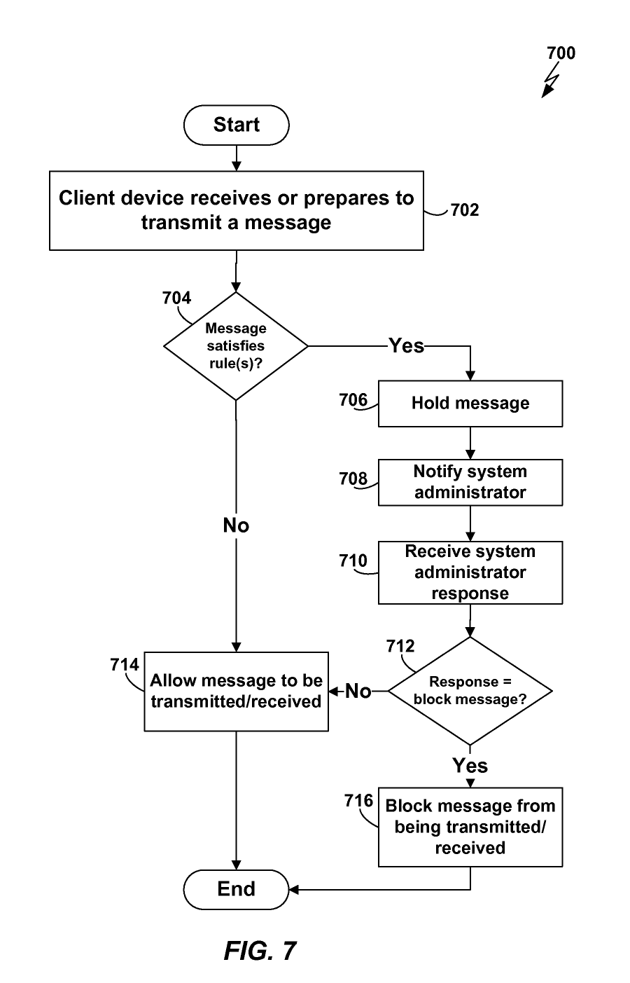

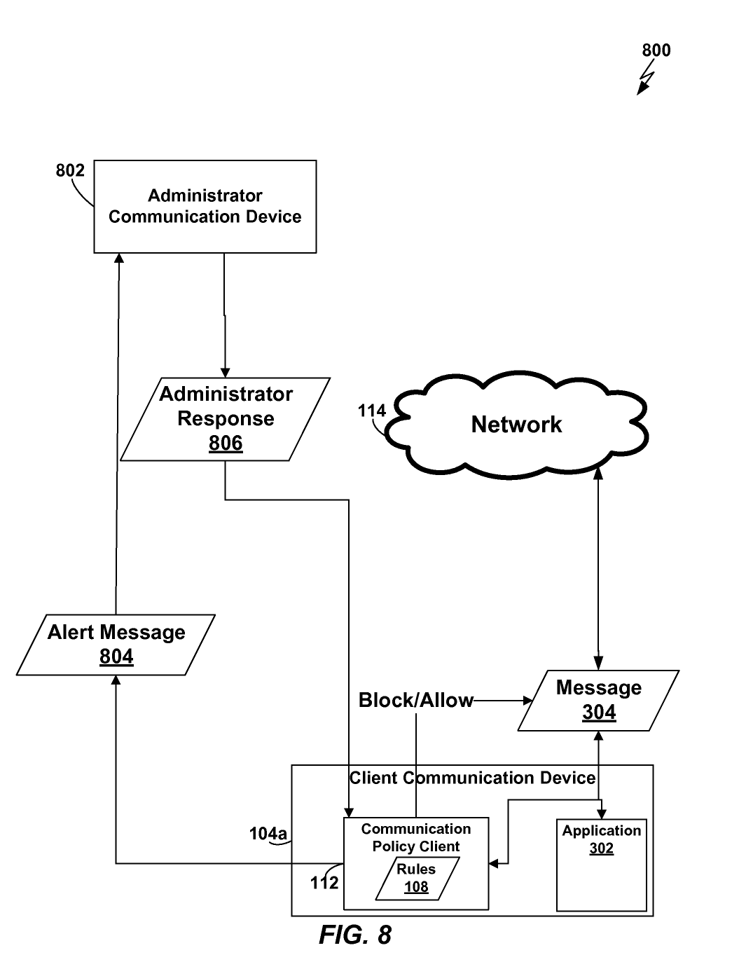

As an example of another layer of intervention, the transmission/reception of messages may be delayed until they are inspected by a system administrator or other authorized user. A flowchart of a method 700 for performing such inspection according to one embodiment of the present invention is shown in FIG. 7. A dataflow diagram of a system 800 for performing the method 700 of FIG. 7 is shown in FIG. 8.

For example, if the client 112 receives or is about to transmit a message 304 (step 702) and determines that the message satisfies one of the rules 108 (step 704), the client 112 may hold the message 304 but not delete it (step 706). The client 112 may send an alert message 804 to a system administrator or other authorized user at another communication device 802, notifying the authorized user that a suspect message has been identified, and providing the authorized user with relevant information, such as the contents of the suspect message (step 708). Although the message 804 is shown as being transmitted directly from the client device 104a to the administrator device 802 for ease of illustration, this and other messages may be transmitted over the network 114 or using other means.

Note that the administrator communication device 802 may be: (1) the same device as that on which the communications server 102 is implemented, (2) one of the client communication devices 104a-n (either the same or a different communication device than the receiving/transmitting client communication device 104a); or (3) a device other than the devices in (1) and (2), such as a dedicated system administrator workstation connected to the communications server 102 over the network 114. As these possibilities indicate, the authorized user's device, which receives the alert message, may be neither a sender nor a recipient of the rule-triggering message.

The authorized user reviews the alert message 804 and responds to the client 112 by transmitting a response 806, indicating either that the message should be allowed or that it should be blocked. The client 112 receives the response 806 from the administrator device 802 (step 710) and acts accordingly (step 712), either allowing the message to be received/transmitted by the device 104a (step 714), or blocking it (step 716). Allowance and blocking of the message may be performed in any of the manners described above. Note that in either case, the review process is transparent to the user of the device 104a. In particular, the client device 104a may initiate transmission of an allowed message from the client device 104a, not from the server 102, in the allowed message's original form. For example, an allowed SMS message may be transmitted by the client device 104a as an SMS message originating from the end user of the device 104a, even if the alert message 804 transmitted by the client 112 to the authorized user took a different form, such as the form of an email message.

The alert message 804 and the authorized user's response 806 may take any form and be transmitted in any manner. For example, they may take the form of email messages or HTTP messages. The server 102 may provide notification to the authorized user notifying the authorized user that a new alert message has been received, or the authorized user may log into the server 102 periodically and review and respond to any pending alert messages at that time.

While the review process is in progress and the message is delayed by the client 112 (e.g., during steps 706-710 in FIG. 7), the client 112 may notify the user of the device 104a that the message 304 has been flagged as a suspect message, and that the message 304 is being audited before being received/sent. Alternatively, the review process may be silent (i.e., performed without notifying the user of the device 104a).

Embodiments of the present invention may handle files and attachments included within or otherwise associated with messages. For example, the client 112 may block and delete files based on the file type. The client 112 may also scan the content of attachments and use the same lexicon or content-based rules for monitoring such files. The client 112 may send the file to the server 102 for further analysis if the file type is not recognized or if the analysis requires too much computation power from the device 104a. For example, images may be sent to the server for optical character recognition (OCR), and the text in the images may be scanned using the content based policies. OCR is computationally intensive and may take a long time on a weak processor such as those available on mobile devices. Furthermore, battery may be drained quickly if demanding algorithms are performed by the device 104a. Once the server 102 reaches a conclusion it can either send the decision to the client 112, or it can tag the file with certain tags based on the analysis. The tagged file can then be sent to the device 104a, and the client 112 can decide based on the local policies 108 and the tags what should be done with the file.

As another example, assume that the client device 104a receives an email message with an attachment, and that any of the techniques disclosed herein are used to scan and tag the attachment. If the user of the client device 104a then attempts to forward the original email, or to send another message containing the attachment, the attachment need not be scanned again for compliance with the client device's rules, since it has already been scanned and tagged. Instead, the communication policy client 112 on the client device 104a may use the existing tags on the attachment to determine which actions, if any, to take in connection with transmission of the attachment. This can save valuable processing, memory, and power resources at the client device 104a, which is particularly beneficial if the client device 104a is a mobile device in which such resources are limited. This technique may be used whether or not the transmission of the attachment by the client device 104a takes the same form as that in which the attachment was originally received. For example, the attachment may have originally been received at the client device 104a in an email but then transmitted by the client device 104a in an SMS message. Furthermore, this technique may be applied whether or not the client device 104a originally received the attachment in a message that passed through the company's servers, and whether or not the client device 104a attempts to transmit the attachment in a message that passes through the company's servers.

It should be appreciated that file tagging may be performed by other systems as well in order to mark files based on their content. Files can be tagged based on their content by a server or a computer prior to being passed to the mobile device. If a user wants to send a tagged file using any communication channel, the client 112 make decisions without scanning the file in real time, saving both time for the user and power for the device 104a.

Although in certain examples described above, all messages sent and received by the client device 104a are archived, this is not a limitation of the present invention. Alternatively, for example, the client device 104a may only archive those messages defined by an archiving policy. For example, the archiving policy of the client communication device 104a may be the same as the policy applied by the client communication device 104a to filtering of messages. In this case, only incoming/outgoing messages which satisfy the local rules 108 of the client device 104a are archived by the client device 104a. Alternatively, for example, the communications server 102 may define and provide the client device 104a a separate set of archiving rules to be used by the client device 104a to determine which messages to archive. In this case, the client device 104a uses one policy to filter messages and another policy to archive messages.

Embodiments of the present invention have a variety of advantages. For example, embodiments of the present invention overcome the problem of prior art systems which are only capable of applying communication policies to messages which pass through a company's servers or gateways. In contrast, embodiments of the present invention can apply communication policies even to messages which are transmitted from one mobile device through another, such as PIN-to-PIN messages, without passing through the company's servers or gateways. As a result, the company obtains the benefit of enforcing its communication policies on all devices used by members of the company, even when such devices send and receive messages which do not pass through the company's servers or gateways. Such enforcement may, for example, be performed by the mobile devices themselves. Such a system combines the benefits of centralized communication policies with the benefits of non-centralized communication. The same benefits apply to archiving of messages, which may be performed in a distributed manner by the mobile devices themselves to create a centralized archive which includes copies of messages which did not pass through the company's servers or gateways.

Another benefit of embodiments of the present invention is that although communication policies may be enforced by individual mobile devices against the messages transmitted and received by such devices, the policies themselves may be centrally created and controlled. A server may transmit policies that are suitable for a particular mobile device to that mobile device. In response, the mobile device may enforce the centrally-created policies. If those policies are subsequently updated centrally at the server, the server may push the updated policies down to the mobile device, which may subsequently enforce the updated policies. Such a scheme combines the advantage of centralized creation and control of communication policies with distributed enforcement of such policies.

Another advantage of embodiments of the present invention is that they make it difficult or impossible for users of client devices to thwart archiving or enforcement of communication policies. As described above, certain prior art systems which rely on a server to request message information from mobile devices may be circumvented by the user by performing actions such as turning off the mobile device before it receives the request from the server. Embodiments of the present invention are immune to such efforts. Because a communication policy client may be installed on the mobile devices themselves, such a client may be configured to proactively apply communication policies to incoming and outgoing messages, and to proactively archive such messages, whether or not a request to do so is received from a server, and whether or not the server is up or accessible over the network. Furthermore, even if the client's initial attempt to transmit information (such as archiving information) to the server fails, the client may repeat its attempts until they succeed. For these and other reasons described above, embodiments of the present invention are more impervious to circumvention than prior art techniques.

Yet another advantage of embodiments of the present invention is that they may be used to transmit a variety of information back to a central server to perform logging and other functions. In contrast, prior art techniques typically transmit only phone numbers from the mobile device to the server for archiving. As described above, this can be disadvantageous because, for example, e-discovery systems usually provide search capabilities that are based on email addresses. Embodiments of the present invention may provided such email addresses, or other useful information, to the server automatically, thereby making the resulting log files more useful for a variety of purposes.

As described above, the transmission/reception of messages may be delayed until such messages are inspected by a system administrator or other authorized user. This approach combines the benefits of distributed automated policy enforcement with the trained eye and discretion of a system administrator. In particular, this approach provides more flexibility than a purely automated system, and may reduce the number of false negatives (i.e., messages blocked by the system which should be allowed), because a system administrator has the authority to allow messages which would otherwise be blocked by the applicable communication policies. At the same time, this approach does not overburden the system administrator, because the system only requires the system administrator to review those messages which are flagged as being prohibited by the applicable communication policies, and because the system may provide the system administrator with a variety of information for evaluating the flagged message, such as the content of the message itself and the identity of the rule(s) which caused the message to be flagged.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

For example, although certain embodiments disclosed herein may be described in connection with “mobile” or “wireless” computing devices, the techniques disclosed herein are not limited to use with mobile and/or wireless devices. Rather, the techniques disclosed herein may be used with devices which are fixed (e.g., desktop computers) and/or wired (e.g., a mobile computing device connected to the Internet using an Ethernet cable).

Furthermore, although certain examples of mobile device platforms and operating systems are provided herein, the techniques disclosed herein are not limited to use with such particular examples of mobile device platforms and/or operating systems. Rather, the techniques disclosed herein may be used in conjunction with any mobile device platform and/or operating system.

Terms such as “message” and “communication” as used herein may refer to any data that may be transmitted from one computing device to another over a network connection. Messages and communications may be transmitted using any protocol and are not limited to containing any particular kind of content.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor menory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A method performed by a first computing device, the method comprising:
(A) receiving a rule from a second computing device that differs from the first computing device;
(B) storing the rule;
(C) determining whether a message at the first computing device satisfies the rule; and
(D) taking an action specified by the rule if the message is determined to satisfy the rule.

2. The method of claim 1, wherein (A) comprises receiving the rule over a network from the second computing device.

3. The method of claim 1, wherein the rule comprises the action and a message filter;
wherein (C) comprises determining whether the message passes the message filter; and
wherein (D) comprises taking the action if the message is determined to pass the message filter.

4. The method of claim 3, wherein (C) comprises determining whether content of the message passes the message filter.

5. The method of claim 4, wherein (C) comprises determining whether an attachment of the message passes the message filter.

6. The method of claim 3, wherein (C) comprises determining whether an address of a sender of the message passes the message filter.

7. The method of claim 3, wherein (C) comprises determining whether an address of a recipient of the message passes the message filter.

8. The method of claim 7, wherein (C) further comprises determining whether an address of a sender of the message passes the message filter.

9. The method of claim 3, wherein (C) comprises determining whether at least one of a time of transmission of the message and a time of receipt of the message passes the message filter.

10. The method of claim 3, wherein (C) comprises determining whether a location of the first device passes the message filter.

11. The method of claim 3, wherein (C) comprises determining whether any combination of the following passes the message filter: content of the message, an address of a sender of the message, an address of a recipient of the message, a time of transmission of the message, a time of receipt of the message, and a location of the first device.

12. The method of claim 3, wherein determining whether the message passes the message filter comprises:
determining whether the message is of a type to which the rule applies; and
determining whether the message satisfies the rule in response to determining that the message is of a type to which the rule applies.

13. The method of claim 1, wherein (A) comprises receiving a policy from the second computing device, the policy comprising a plurality of rules including the rule; and
wherein the method further comprises performing (B), (C), and (D) for each of the plurality of rules.

14. The method of claim 1, wherein the message comprises a personal identifier of at least one of a human sender of the message and a human recipient of the message.

15. The method of claim 14, wherein the personal identifier comprises a telephone number.

16. The method of claim 1, wherein the message comprises one of an email message, an SMS message, an MMS message, an instant message, and a PIN-to-PIN message.

17. The method of claim 1, wherein (C) is performed in response to detection of an attempt by the first computing device to transmit the message.

18. The method of claim 17, wherein (D) comprises blocking the message from being transmitted by the first computing device if the message is determined to pass the message filter.

19. The method of claim 17, wherein (D) comprises allowing the message to be transmitted by the first computing device if the message is determined to pass the message filter.

20. The method of claim 1, wherein (C) is performed in response to detection of receipt by the first computing device of the message.

21. The method of claim 20, wherein (D) comprises blocking the message from being displayed to a user of the first computing device if the message is determined to pass the message filter.

22. The method of claim 20, wherein (D) comprises allowing the message to be displayed to a user of the first computing device if the message is determined to pass the message filter.

23. The method of claim 1, wherein (D) comprises:
(D) (1) notifying a user of a third computing device that the message has been determined to satisfy the rule.

24. The method of claim 23, wherein the third computing device comprises the first computing device.

25. The method of claim 23, wherein the third computing device comprises the second computing device.

26. The method of claim 23, wherein the third computing device differs from the first computing device and the second computing device.

27. The method of claim 23, wherein (D) further comprises:
(D) (2) receiving a modified version of the message from the user.

28. The method of claim 23, wherein (D) further comprises:
(D) (2) receiving an instruction from the user in response to the notification.

29. The method of claim 28, wherein (D) further comprises:
(D) (3) transmitting the message in response to receiving the instruction.

30. The method of claim 28, wherein (D) further comprises:
(D) (3) blocking transmission of the message in response to receiving the instruction.

31. The method of claim 28, wherein (D) further comprises:
(D) (3) displaying the message in response to receiving the instruction.

32. The method of claim 28, wherein (D) further comprises:
(D) (3) blocking display of the message in response to receiving the instruction.

33. The method of claim 1, wherein the second computing device is neither a sender nor a recipient of the message.

34. The method of claim 1, wherein the first computing device performs (C) and (D) without communicating with the second computing device.

35. The method of claim 1, wherein the first computing device performs (C) and (D) while there is no network connection between the first computing device and the second computing device.

36. A computer-implemented method comprising:
(A) at a communication policy server, transmitting a first rule to first and second client communication devices;
(B) at the first client communication device:
(1) storing the first rule;
(2) determining whether a first message at the first client communication device satisfies the first rule;
(3) taking an action specified by the first rule if the first message is determined to satisfy the first rule;
(C) at the second client communication device:
(1) storing the first rule;
(2) determining whether a second message at the second client communication device satisfies the first rule; and
(3) taking the action specified by the first rule if the second message is determined to satisfy the first rule.

37. The method of claim 36, further comprising:
(D) at the communication policy server, modifying the first rule to produce a modified first rule; and
(E) at the communication policy server, transmitting the modified first rule to the plurality of client communication devices.

38. The method of claim 36, wherein (B) (1) comprises storing the first rule on the first one of the client communication devices.

39. The method of claim 36, further comprising:
(D) at the communication policy server, transmitting a second rule to the first client communication device and not to the second client communication device.

40. The method of claim 36, wherein (B) (2) comprises using an instance of a communication policy client to determine whether the first message satisfies the first rule;
wherein (B) (3) comprises transmitting the first message to a third client communication device which differs from the first and second client communication devices, wherein no instance of the communication policy client is installed on the third client communication device.

41. The method of claim 36, wherein (B) (2) comprises using an instance of a communication policy client to determine whether the first message satisfies the first rule; and
wherein the method further comprises:
(D) at a third client communication device which differs from the first and second client communication devices, transmitting the first message to the first client communication device, wherein no instance of the communication policy client is installed on the third client communication device.

42. A method performed by a first computing device, the method comprising:
(A) detecting a first message at the first computing device, the first message having a second computing device as its sender or recipient;
(B) creating an archiving message based on the first message;
(C) storing the archiving message securely on a computer-readable medium in the first computing device; and
(D) transmitting the archiving message to a third computing device for storage in an archive.

43. The method of claim 42, wherein (C) comprises storing the archiving message in a form which hides contents of the archiving message from users of the first computing device.

44. The method of claim 43, wherein (C) comprises storing the archiving message in an encrypted form.

45. The method of claim 43, wherein (C) comprises storing the archiving message in a file having a hidden file attribute in a file system.

46. The method of claim 42, wherein (C) comprises storing the archiving message in a form that is protected against deletion and modification by users of the first computing device.

47. The method of claim 46, wherein (C) comprises storing the archiving message in a file having limited access privileges.

48. The method of claim 42, wherein (B), (C), and (D) are performed in response to detection of the first message at the first computing device.

49. The method of claim 42, further comprising:
(E) receiving a rule over a network from a second computing device;
(F) determining whether the first message at the first computing device satisfies the rule; and
wherein (B), (C), and (D) are performed in response to determining that the first message satisfies the rule.

50. The method of claim 42, wherein (D) comprises:
(D) (1) attempting to transmit the archiving message to the third computing device;
(D) (2) determining whether the transmission in (D) (1) succeeded;
(D) (3) re-attempting the transmission of the archiving message to the third computing device if the transmission in (D) (1) failed; and
(D) (4)) repeating (D) (2) and (D) (3) until transmission of the archiving message to the third computing device succeeds.

51. The method of claim 42:
wherein (A) comprises receiving or transmitting the first message over a first communication channel using a first communication protocol; and
wherein (D) comprises transmitting the archiving message over a second communication channel using a second communication protocol that differs from the first communication protocol.

52. The method of claim 51, wherein (A) comprises receiving the first message according to the first protocol, and wherein (D) comprises transmitting the archiving message according to the second protocol.

53. The method of claim 51, wherein the first protocol comprises a non-email protocol, and wherein the second protocol comprises an email protocol.

54. The method of claim 42, wherein the archiving message comprises the first message.

55. The method of claim 42, wherein the archiving message comprises an identifier of the first computing device.

56. The method of claim 42, wherein the archiving message comprises an identifier of a user of the first computing device.

57. The method of claim 56, wherein (B) comprises:
(B) (1) identifying a telephone number of the first computing device; and
(B) (2) identifying the identifier of the user based on the telephone number.

58. The method of claim 42, wherein the archiving message comprises an identifier of a recipient of the first message.
